(19) United States
(12) Patent Application Publication
(10) Pub. No.: US 2009/0092777 A1
(43) Pub. Date: Apr. 9, 2009

(54) PACKAGE HAVING A PRINTED LAMINATE

(76) Inventors: Cori K. Kohl, Appleton, WI (US); Mark E. Jansen, Appleton, WI (US)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 12/197,721

(22) Filed: Aug. 25, 2008

Related U.S. Application Data
(63) Continuation-in-part of application No. 12/019,407, filed on Jan. 24, 2008.
(60) Provisional application No. 60/887,631, filed on Feb. 1, 2007.

(51) Int. Cl. B32B 1/04; B32B 37/02

(52) U.S. Cl. 428/35.2; 156/60

(57) ABSTRACT

A package is fabricated with a first matte polymer film having reverse printed matter thereon, a second polymer film laminated to the first matte polymer film to provide a composite, wherein the printed matter is between the first and second polymer films, and a woven bag enclosed by the composite, wherein the second polymer film of the composite isolates the printed matter from cross contamination with contents intended for the woven bag.

### CROSS REFERENCE TO RELATED APPLICATIONS

This application is a continuation-in-part of Ser. No. 12/019,407, filed Jan. 24, 2008, which claims the benefit of U.S. Provisional Patent Application No. 60/887,631, filed Feb. 1, 2007.

### FIELD OF THE INVENTION

The present invention relates to a laminated package or bag for packaging food and non-food items, and methods for making the same.

### BACKGROUND OF THE INVENTION

Typically, woven bags are a reverse printed film polymer (“poly”) laminated by poly adhesive to a woven material so as to provide a structure (film/print/poly/woven). When the bags are filled with food (human and animal) products, they frequently are filled hot and with grease added. As a result, the moisture or grease or heat can attack the printing by migration through the poly and woven layers. Moreover, the printed film is subject to abrasion by the woven bag.

U.S. Pat. No. 7,111,986 discloses a package that utilizes a reverse printed film adhesive laminated to another film. This would be film/print/adhesive/film. Such a package is used for ream wrap and packaging cosmetics, and a variety of foods from potato chips, to pouches for a variety of edibles, such as, soup and dog treats.

In both the single film laminated woven bag and other film packaging, the outer film of such packages is glossy in nature, which allows the cross-hatch pattern of the woven material to be quite evident. The present invention serves to improve the overall appearance of woven bags, by replacing the typical glossy film with a matte film as the outer ply of the laminated structure.

### SUMMARY OF THE INVENTION

A package is fabricated with a first non-glossy (matte) polymer film having reverse printed matter thereon, a second polymer film laminated to the first matte polymer film to provide a composite, wherein the printed matter is between the first and second polymer films, and a woven bag enclosed by the composite, wherein the second polymer film of the composite isolates the printed matter from cross contamination with contents intended for the woven bag. The present invention replaces a conventional “glossy” film with a matte film as the outer ply of the laminated structure.

According to an embodiment of the invention, a combination of matte film/print/poly film/woven comprises an improvement over a package constructed of poly (polymer) film adhesive or poly laminated to woven material.

In accordance with the present invention, utilizing a matte film as the outer ply of the bag lamination significantly minimizes the woven appearance, producing an aesthetically pleasing woven bag. An alternative method is to use a matte overprint varnish or coating on the outside of the bag structure, which also significantly minimizes the woven appearance. Such a varnish or coating could be applied by flexography, rotogravure, or any type of printing or coating process. In embodiments, a matte film or film overprinted with matte varnish may be directly laminated to woven material to form the bag structure.

In further embodiments, the matte coat weight may range from about 0.5 lb./3000 ft.² to about 3.0 lbs./3000 ft.². The coating may be applied on a printing press or coater, which can run at line speeds of from about 50 to about 2000 fpm. The matte coating is preferably applied at room temperature, i.e., about 65-90° C.

Films laminated together are poly laminated by heating, melting and fusion of a poly film, or they are laminated together by being adhesive laminated to each other and to the woven bag. The second layer of poly film with the printing buried between two layers protects the print by providing a higher barrier to moisture and grease cross contamination, in addition to providing a supplemental barrier layer for the bag to resist opening of the bag by penetration of the printed film caused by damage to the bag. Further, the second layer of poly film increases the resistance to tensile forces to protect the woven bag from tearing when the bag as a whole is lifted or tugged upon.

Alternatively, a layer of reverse-printed poly film is laminated by adhesion and/or heat lamination methods to woven fabric material to form the woven bag structure. The printed matter is “buried” between the film and woven material, which protects the package from ink scuffing and rubbing off.

A laminated and woven bag provides enhanced barrier properties, preventing the contents intended for containment in the bag from attacking the print surface. The present invention would make a film layer as a composite of combined two films adhesive laminated or poly laminated together and forming respective barriers to isolate the ink therebetween, or alternatively, a single layer of reverse-printed poly film laminated to a woven layer.

The adhesive is provided by a thermoplastic or pre-polymerized thermoset adhesive material, transparent, translucent, opaque, semi-opaque, possessing color or lacking color, that is spread into a thin layer and activated to an adhesive state by one or more of heat, pressure sensitivity or polymerization from a pre-polymerized state, for example, by extrusion, and then placed between the first printed poly film and the second poly film to form the composite.

The poly laminate comprises a thermoplastic or pre-polymerized thermoset polymer film that is supplied as a thin layer, then placed between the first printed poly film and the second poly film, followed by being activated to an adhesive state similarly as is the adhesive material, described herein. Advantageously, the invention eliminates the risk of cross contamination of inks and contents intended for woven bag contents. Moreover, the invention allows for risk-free utilization of water based inks when packaging hot filled or greasy food products in woven bags. The composite protects the ink from abrasion by the woven bag. The product is a multi-layer bag embodiment comprising an outer layer of a matte film (with a thickness in a range of about 9 microns to about 150 microns, including, but not limited to a preferred thickness of about 18 microns) adhesive laminated (with about 0.5 to 20 pounds per 3,000 sq feet of adhesive) to another film (clear, colored, metallized, or treated in some way), (with a thickness in a range of about 9 microns to about 150 microns, including, but not limited to a preferred thickness of about 18 microns). The film lamination is then poly laminated (with about 5 to about 30 pounds of poly per 3,000 sq feet) to a woven mesh tube or flat sheet (with a basis weight of about 30 to about 100 pounds per 3,000 sq feet of a single ply of woven). The material is then formed or cut into a bag.

The final structure is matte film/print/adhesive/film/poly/woven, or alternatively a matte film/print/adhesive/woven structure. The adhesive layer also could be a poly layer (of about 5 to 30 pounds per 3,000 sq feet) resulting in a structure of matte film/print/poly/film/poly/woven. All product weights are based on a single layer of the structure, i.e. if it is a tube it is one side or layer of the tube. Alternatively, it is anticipated that non-woven materials could effectively replace the woven materials as noted above.

### BRIEF DESCRIPTION OF THE DRAWINGS

FIG. 1 is a schematic view of a manufacturing apparatus performing a method of making a composite having a transparent outer film with a printed area that repeats along a continuous length of the film, an adhesive layer and another film adhered by the adhesive layer to the outer film.

FIG. 2 is a schematic view of a manufacturing apparatus performing a method for making a woven bag from the composite of FIG. 1 and woven bag material.

FIG. 3 is a schematic view in cross section of one embodiment of a woven bag.

FIG. 4 is a schematic view in cross section of another embodiment of a woven bag.

### DETAILED DESCRIPTION OF THE INVENTION

US 2007/0140600 A1, U.S. patent application Ser. No. 11/538,838 filed on Oct. 5, 2006 discloses a woven bag laminated to a reverse printed film. Prior to the invention, the previously known method of making a product was reverse printing a film and poly laminating it to a woven bag material. However, this can cause ink smear when the moisture or grease of the product within or while filling the bag migrates through the woven bag material to contact and re-liquefy the water based ink.

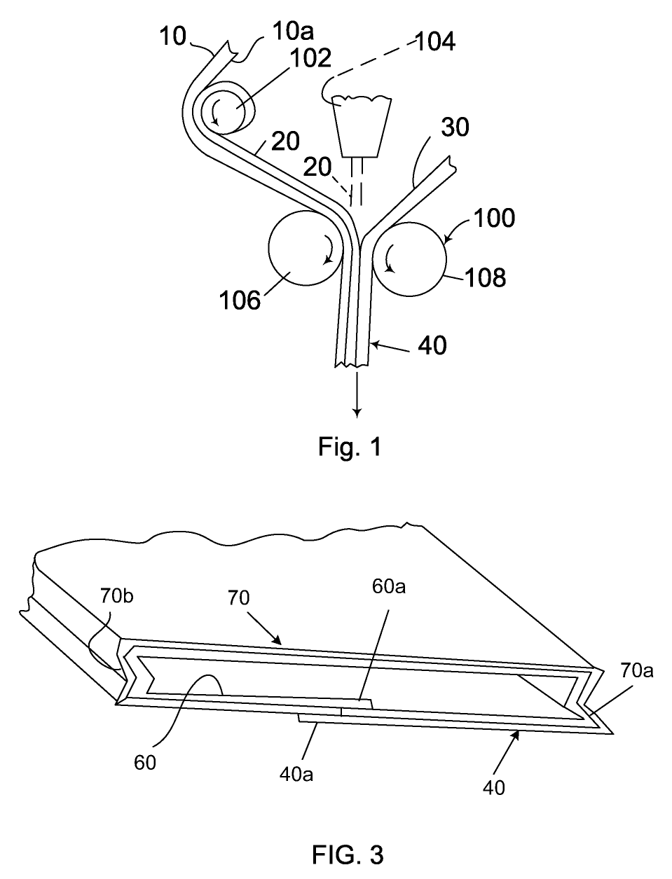

FIG. 1 discloses a portion of a continuous poly matte film 10 having a reverse printed area 10a. The printed area 10a repeats along a length of the continuous poly matte film 10 to correspond with each bag or package 70, FIGS. 3 and 4, which is formed, in part, by the continuous film 10. The repeated reverse printed area 10a is bounded by an unprinted top margin forming a top of a bag type package 70, an unprinted bottom margin forming a bottom of the bag type package 70 and unprinted side margins 40b, and 40c.

Each repeated printed area corresponds to a printed area on a woven bag product 70, in one embodiment having the printed area visible on at least one broad side or front of the bag 70 and, in another embodiment, preferably on both sides, front and back, of the bag 70. In a further embodiment, the printed area extends over sides 70a, 70b of the bag 70, which sides 70a, 70b expand and contract with the amount of contents within the bag 70.

FIG. 1 discloses an apparatus 100 for making a composite 40. The composite 40 comprises the reverse printed matte film 10 having the printed area 10a, an adhesive layer 20 or tie layer applied to the printed side of the reverse printed matte film 10 by an adhesive applicator roller 102 of the apparatus 100. Alternatively, the adhesive layer 20 comprises a poly laminate 20 extruded as a heated film or sheet from an extruder 104, shown in phantom outline. The matte film 10 can be printed utilizing ink 10a with a solvent based carrier (called solvent printing) or utilizing a water based carrier (called water based printing). Water based printing has been growing in use over the past decade due to the need to reduce ink solvent emissions and waste treatment. Printers utilizing solvent based printing need solvent recovery systems or incinerators to burn off excess solvent rather than emitting it to the environment. These solvents, such as toluene, are known carcinogens. Printing with water based inks 10a causes little or no solvent emissions and is better for the environment. However, when making bags 70, FIGS. 3 and 4 for foods that are packaged hot (+90° F.) or that have excess grease (mainly animal feeds like dog food), the water based ink 10a can be attacked by water vapor or grease migrating from the bag contents. This will cause the ink 10a to degrade and run or smear when contacted by and mixed with moisture vapor. The result is smeared printing 10a. Further, the ink 10a and the migrating bag contents cross-contaminate one another.

FIG. 1 discloses laminating nip rollers 106, 108 of the apparatus 100, which counter rotate to apply pressure and necessary heat to an adherent state temperature to laminate the layers 10, 10a, 20 and 30 and form the flexible composite 40.

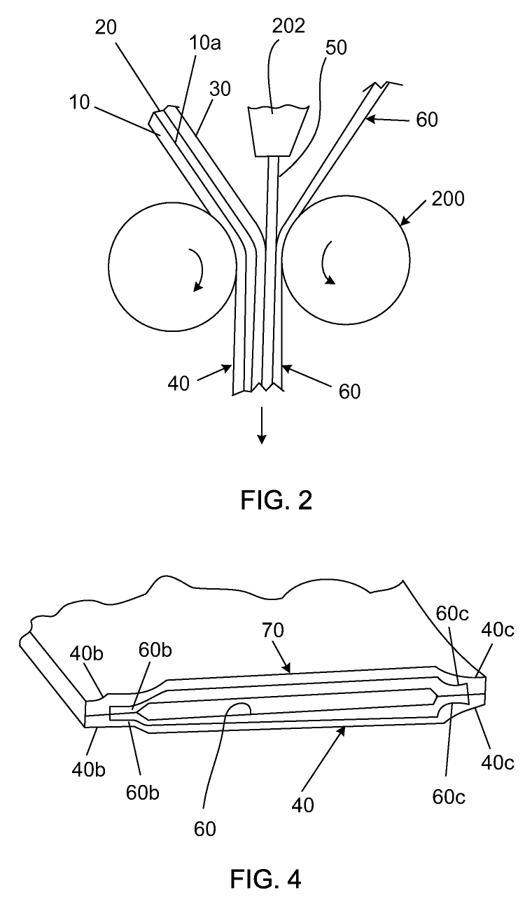

By making a bag 70, FIGS. 3 and 4, having a composite 40 that comprises a reverse printed matte film 10 laminated to another layer of film 30, the print 10a is now confined between the two film layers 10, 30 so that it is isolated between the two films 10, 30 from mutual cross contamination and attack by moisture or grease. Further, the print 10a is protected by an intervening film 30 from abrasion by the woven bag material 60, FIGS. 2, 3 and 4 that forms an enclosure to contain the bag contents.

A preferred embodiment of the invention comprises: matte poly film 10 (with a thickness in a range of about 9 microns to about 150 microns, including, but not limited to a preferred thickness of about 18 microns) adhesive or poly laminated (with about 0.5 to about 20 pounds of adhesive 20 or alternatively, poly laminate 20, per 3,000 sq. feet of film) to another film 30, for example, (clear, colored, metallized, or treated in some way), (with a thickness in a range of about 9 microns to about 150 microns, including, but not limited to a preferred thickness of about 18 microns).

In FIG. 2, the film lamination comprises a composite 40 that is then poly laminated by an apparatus 200 (with about 5 to about 30 pounds of poly laminate 50 or, alternatively, adhesive layer 50, per 3,000 sq. feet) applied as a heated film or sheet of poly laminate by an extruder 202 of the apparatus 200, to a woven mesh tube 60 or flat sheet 60 (with a basis weight of about 30 to about 100 pounds per 3,000 sq feet of a single ply of woven). Alternative to the poly laminate 50, an adhesive layer 50 is applied by another applicator roller similar to the applicator roller 102 shown in FIG. 1. All product weights are based on a single layer of the structure, i.e. if it is a tube it is one side or layer of the tube. The material structure is then formed or cut into a bag 70. The final structure comprises matte film 10/print 10a/adhesive 20 or poly 20/film 30/poly 50 or adhesive 50/woven bag material layer 60.

An alternative embodiment of the invention replaces the adhesive layer 20 with about 5 to about 30 pounds per square feet of poly 20. The resulting structure comprises the successive layers of matte film 10/print 10a/poly 20/film 30/poly 50/woven bag material layer 60.

Another alternative embodiment of the invention replaces the poly layer 50 with an adhesive layer 50 (about 0.5 to about 20 pounds per 3,000 sq ft). The resulting structure comprises matte film 10/print 10a/adhesive 20/film 30/adhesive layer 50/woven bag material layer 60.

A best mode process for carrying out the invention is to reverse print the printed matter 10a, on matte film 10 on a wide web press, then lamination of the reverse printed matte film 10 to another film 30 utilizing an adhesive laminator (EB, electron beam, solvent-less, water-based or other), and then lamination of the laminated film composite 40 to the woven bag material 60 using a poly extruder laminator 202. The alternatives use either the poly extruder laminator 202 for both laminations, FIGS. 1 and 2, or the adhesive laminator 104 for both laminations, FIGS. 1 and 2.

A first matte polymer film 10 includes, but is not limited to, one of an oriented polypropylene, OPP, or oriented polyethylene, OPE, biaxial oriented polypropylene, BOPP, or biaxial oriented polyethylene, BOPE, polyester, PET, or other polymer film having an unprinted side with a matte finish, and an opposite side of the same film adapted for printing 10a thereon being treated by, for example, corona, flame, chemical or plasma treatment to increase the adherence of printing inks. The matte film 10 is reverse printed with printed matter 10a, text and graphics, in reverse or mirror image orientation, which is viewed in a readable orientation by looking through the unprinted side of the matte film 10.

The printing operation comprises reverse printing the treated side of the matte film 10 with a printer apparatus including but not limited to, flexographic, rotogravure or other printer apparatus, with a printing image width of about 25-75 inches and an individual repeat length corresponding to the span of successive bags 20-50 inches each, and joined side-to-side or end-to-end along a continuous length of the first film 10. The printing image 10a comprises various text and/or graphics, suitable to print one or both sides of a bag 70 at once. From the printer the matte film 10 is wound onto a take up reel (not shown).

A second polymer film 30 comprised of a polymer material similar to the material of the matte film 10 is laminated over the reverse printed matter 10a on the treated side of the matte film 10. The second polymer film 30 is commercially available as transparent, white or metallized with imbedded metal particles. An adhesive laminator machine 100, commercially available from NORDMECCANICA GROUP, FAUSTEL or DCM, for example, includes but is not limited to, a “solvent-less” adhesive laminator machine or electron beam, EB, adhesive laminator machine that applies an adhesive 20 including, but not limited to, a solvent-less polyurethane adhesive or EB (electron beam) radiation cured acrylate adhesive 20 to the surface of either the matte film 10 or the second film 30. The second film 30 is laminated against the printed side of the matte film 10, including but not limited to the use of nip rollers 106, 108 at an elevated temperature as required by the adhesive manufacturer to activate the adhesive to an optimum adherent state.

A tubular woven bag material 60 or fabric provides a reinforcing mesh for the bag 70. For example, the fabric 60 comprises a uniform weight and poly profile in the machine direction and cross direction.

For example, the mesh 60 comprises about 10×10 picks per inch of warp and weft yarns of about 850 Denier minimum, low density polyethylene of about 60% resin blended copolymer with about 40% polypropylene resin, the mesh having a polymer basis weight of about 16.6 and a coefficient of friction of about 0.5, as measured by the inclined plane method. The tubular woven mesh has a total basis weight range of about 72.3-78.9 gm/m², including preferably a basis weight of about 75.6 gm/m².

FIG. 2 discloses an extrusion laminate of either side of the woven bag material 60 laminated to the untreated, unprinted plain side of the laminated composite 40. The woven bag adhesion withstands about 300 grams minimum force.

FIG. 3 discloses an embodiment of a bag 70, product or package, in which the woven bag material 60 is in the form of a single layer tube, such that the tube has an overlap seam 60a or alternatively is a seamless tube without an overlap seam 60a. The composite 40 comprises a single piece having an overlap seam 40a. The bag 70 is shown partially open for purposes of illustration. During lamination, the bag 70 is formed while collapsed and flat. After laminating together the composite 40 and the woven bag material 60, they are cut to a length that corresponds to the length of an individual bag 70. An individual bag 70 will have open ends. Either or both open ends of the individual bag 70 are capable of being closed and sealed in a similar fashion as disclosed by FIG. 4, wherein FIG. 4 depicts margins 60b, 60c of the woven bag 60 joined together, and margins 40b, 40c of the composite 40 joined together, by melt bonding together under heat and pressure, or by the addition of adhesive to adhesive bond together.

FIG. 4 discloses an embodiment of a bag 70, product or package, in which the woven bag material 60 is in the form of a flat sheet of fabric, which is slit to form two pieces with side margins 60b and 60c. The two pieces are laminated to each other along the side margins 60b and 60c. The composite 40 is slit to form two pieces covering the two opposite sides of the woven bag material 60. The two pieces of the composite 40 are laminated to the sides of the woven bag material 60, and further are laminated together along their side margins 40b and 40c. The bag 70 is shown partially open for purposes of illustration. During lamination, the bag 70 is formed while collapsed and flat. The side margins 40b and 40c are trimmed to size. The side margins 60b and 60c are trimmed to size if necessary. After laminating together the composite 40 and the woven bag material 60, they are cut to a length that corresponds to the length of an individual bag 70. An individual bag 70 will have open ends, either one or both of which are capable of being closed. By way of example, either or both open ends of the individual bag 70 are capable of being closed along margins adjacent the open ends in a similar fashion as disclosed by FIG. 4, wherein FIG. 4 depicts margins 60b, 60c of the woven bag 60 joined together, and margins 40b, 40c of the composite 40 joined together, by melt bonding together under heat and pressure, or by the addition of adhesive to adhesive bond together.

Each of the films according to the embodiments of the invention resides in an unreinforced, heavy duty film of sufficient flexural modulus to form a flexible bag of sufficient tensile strength and sliding friction constant, elongation resistance, abrasion resistance and impact resistance at ambient temperatures, which is particularly suited for rough handling of bulk food quantities during shipment and storage. Further, the polymer and film have no solvent at room temperature, are sensitized for printing, and are heat, water and moisture resistant, staining resistant, and chemically resistant to organic chemicals particularly present in bulk food, including but not limited to dog food and birdseed, and further, including but not limited to grains, cereals, oils, grease, gravies and sauces. Accordingly, the polymer and film of the bag are particularly suited for heavy bulk food storage and rough handling during shipment and storage. The outer film is capable of being printed with printing ink of water based solvent of low toxicity and low environmental impact when incinerated or recycled. According to an embodiment of the invention, one or more of the films comprise heavy duty polypropylene.

This description of the exemplary embodiments is intended to be read in connection with the accompanying drawings, which are to be considered part of the entire written description. Weights, measurements and coefficients are expressed as nominal values including values equal to the expressed values and values about the expressed values. In the description, relative terms such as “lower,” “upper,” “horizontal,” “vertical,”, “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Patents, patent applications and publications referred to herein are expressly incorporated in their entireties herein. Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A package comprising:
a matte polymer film having reverse printed matter thereon;
a second polymer film laminated to the matte polymer film to provide a composite, wherein the printed matter is between the matte and second polymer films; and
a woven bag enclosed by the composite, wherein the second polymer film of the composite isolates the printed matter from cross contamination with contents intended for the woven bag.

2. The package of claim 1 wherein the printed matter comprises water based ink.

3. The package of claim 1 wherein the contents intended for the woven bag include but are not limited to dog food and bird seed.

4. The package of claim 1 wherein the composite comprises one piece joined at a seam and laminated to the woven bag.

5. The package of claim 1 wherein the composite comprises two pieces joined together at side margins and laminated to the woven bag.

6. The package of claim 1 wherein the woven bag comprises a single layer tube, the tube is seamless or has a seam, and the woven bag and the composite are laminated together.

7. The package of claim 1 wherein the woven bag comprises two pieces joined together at side margins, and the woven bag and the composite are laminated together.

8. The package of claim 1 wherein the woven bag comprises two pieces joined together at side margins, the composite comprises two pieces joined together at their side margins, and the composite and the woven bag are laminated together.

9. The package of claim 1 wherein the composite comprises the first film of reverse printed clear polymer film with a thickness of about 9 microns to about 150 microns, an adhesive of about 0.5 to about 20 pounds per 3,000 square feet, and the second film of a polymer with a thickness of about 9 microns to about 150 microns.

10. A method of making the package of claim 1, comprising:
laminating the second polymer film to the matte polymer film and over the printed matter to provide the composite; and
laminating the composite to the woven bag to provide a bag having opened ends, wherein one or both ends are capable of being closed.
